(19) United States
(12) Patent Application Publication
(10) Pub. No.: US 2026/0332591 A1
(43) Pub. Date: Oct. 22, 2026

(54) NETWORK SERVER STATUS MANAGEMENT

(71) Applicant: Juniper Networks, Inc., Sunnyvale, CA (US)

(72) Inventors: Sundar Raju S R, Trichy (IN); Santosh Popat Rokade, San Jose, CA (US); Wesley Purvis, Yardley, PA (US); Posen Hung, San Jose, CA (US)

(21) Appl. No.: 19/331,691

(22) Filed: Sep. 17, 2025

(30) Foreign Application Priority Data
Apr. 16, 2025 (IN) 202541036880

(51) Int. Cl. H04L 9/40; H04L 67/5682

(52) U.S. Cl. CPC H04L 63/10; H04L 63/0892; H04L 67/5682

(57) ABSTRACT

Techniques are disclosed that enable a network access device to manage network servers. The techniques include initiating, for a first set of client devices, a first server check of a network server, wherein the network access device is configured to use the network server for the first set of client devices and a second set of client devices. Based on the first server check, the techniques include updating a cache of the network access device with a status of the network server and performing, for the second set of client devices, a lookup in the cache of the network access device for the status of the network server. Based on the lookup in the cache, the techniques include determining whether to initiate, for the second set of client devices, a second server check of the network server.

This application claims the benefit of IN Provisional Patent Application No. 202541036880, filed 16 Apr. 2025, the entire contents of which is incorporated herein by reference.

### TECHNICAL FIELD

The disclosure relates generally to computer networks and, more specifically, to managing network servers configured for network access devices within computer networks.

### BACKGROUND

Commercial premises or sites, such as offices, hospitals, airports, stadiums, or retail outlets, often install complex wireless network systems, including a network of network access server (NAS) devices, e.g., wireless access points (APs), switches, and/or other network access devices, throughout the premises to provide wireless network services to one or more client devices. APs, for example, are physical, electronic devices that enable other devices to wirelessly connect to a wired network using various wireless networking protocols and technologies, such as wireless local area networking protocols conforming to one or more of the IEEE 802.11 standards (i.e., “WiFi”), Bluetooth/Bluetooth Low Energy (BLE), mesh networking protocols such as ZigBee or other wireless networking technologies.

Many different types of client devices, such as laptop computers, smartphones, tablets, wearable devices, appliances, and Internet of Things (IoT) devices, incorporate wireless communication technology and can be configured to connect to NAS devices. In order to gain access to a wireless network, a client device may first need to authenticate to the NAS device. Authentication may occur via a handshake exchange between the client device, the NAS device, and an Authentication, Authorization, and Accounting (AAA) server controlling access to the wireless network at the NAS device.

### SUMMARY

In general, this disclosure describes one or more techniques for a network access server (NAS) device to maintain a cache that stores statuses associated with network servers, e.g., Authentication, Authorization, and Accounting (AAA) servers, configured for the NAS device. In accordance with the disclosed techniques, the cache enables propagation of the network server statuses across sets of client devices, e.g., sets of client devices corresponding to basic service sets (BSSes), wireless local area networks (WLANs), and/or frequency bands managed by the NAS device. In this way, the disclosed techniques avoid redundant server checks and facilitate proactive network server failover and/or fallback across supported sets of client devices at the NAS device.

As one example, a NAS device may support multiple BSSes or wireless local area networks (WLANs) on each of one or more frequency bands (e.g., 2.4 GHz, 5 GHz, and/or 6 GHz). The NAS device may be configured with a set of AAA servers for each BSS or WLAN at each frequency band supported by the NAS device. For example, the set of AAA servers may include a primary AAA server that is preferably used for authentication and accounting requests for the BSS and a secondary AAA server that is used in the case of failure of the primary AAA server. In order to facilitate proactive AAA server failover and fallback, the NAS device periodically performs a server check of an AAA server by sending one or more authentication or accounting requests to the AAA server, and stores a status, e.g., reachable and/or available, of the AAA server in a local cache. If an AAA server configured for a BSS is unreachable and/or unavailable, the NAS device will failover or fallback to another AAA server in the set of the AAA servers configured for the BSS. The NAS device will also update the status of the AAA server in the cache and, based on the cache, propagate the failover or fallback to other BSSes supported by the NAS device that are configured with the same set of AAA servers.

In accordance with the disclosed techniques, the NAS device may include a cache to store a reachability and availability status of each AAA server of the set of AAA servers configured for the BSSes supported by the NAS device. Prior to initiating a server check of an AAA server of the set of AAA servers, the NAS device may perform a lookup of the AAA server in the cache to determine whether a server check is needed. For example, after a failover from a primary AAA server to a secondary AAA server, the NAS device may perform a lookup in the cache for a status of the primary AAA server and determine that the primary AAA server has a positive status (e.g., the primary AAA server is reachable and available) causing the NAS device to not perform another server check of the primary AAA server. In this example, the NAS device may initiate a fallback from the secondary AAA server to the primary AAA server. In another example, after failover from a primary AAA server to a secondary AAA server, the NAS device may perform a lookup in the cache for the status of the primary AAA server and determine that the primary AAA server has a negative status (e.g., unreachable and/or unavailable) causing the NAS device to perform a server check of the primary AAA server.

In some examples, performing server checks of the same AAA servers for multiple BSSes configured with the same set of AAA servers may be redundant and result in inefficiencies and an increased network load. For example, a first and second BSS of a NAS device may be configured with the same set of primary and secondary AAA servers. Conventionally, the NAS device may perform a server check for the first BSS of the primary AAA server and also perform a server check for the second BSS of the same primary AAA server, which is redundant and unnecessary. In another example, when the NAS device performs a failover or a fallback to an AAA server in the set of AAA servers configured for the first BSS, conventionally, the NAS device independently determines whether to failover or fallback for the second BSS and each of the other BSSes configured with the same set of AAA servers, which may again result in increased network workload and inefficiencies. For example, a primary AAA server associated with the first BSS may be unavailable resulting in a failover to a secondary AAA server and de-authentication of a client device connected to the BSS. If the failover is not propagated to the other BSSes associated with the primary AAA server, then client devices connected to each of those other BSSes may also be de-authenticated.

The techniques of this disclosure provide one or more technical advantages and practical applications. The techniques enable a NAS device to maintain a cache that stores statuses of network servers and based on the statuses stored in the cache, propagate failover and/or fallback across WLANs and across frequency bands supported by the NAS device to facilitate proactive failover and fallback across multiple sets of client devices. For example, the NAS device may perform a lookup in the cache for a status of a primary AAA server configured for a BSS. Based on the lookup, the NAS device may determine that a server check of the primary AAA server is required. The NAS device may perform the server check and determine that the primary AAA server has a negative status (e.g., the primary AAA server is unreachable and/or unavailable). The NAS device may update the cache to indicate the status of the primary AAA server as negative, and the NAS device may failover to the secondary AAA server for that BSS. The NAS device may then propagate the failover based on the updated statuses in the cache across BSSes supported by the NAS device. In this way, the NAS device proactively causes the other BSSes to failover to the secondary AAA server. The NAS device may function similarly for fallback to the primary AAA server once the primary AAA server is reachable and available. In this way, techniques of this disclosure potentially avoid redundant server checks on AAA servers configured for multiple BSSes and facilitate propagation of AAA server failover and fallback across the BSSes, such that network loads may be reduced and efficiency may be increased.

In one example, the disclosure is directed to a network access device comprising: memory; and processing circuitry in communication with the memory and configured to: initiate, for a first set of client devices, a first server check of a network server, wherein the network access device is configured to use the network server for the first set of client devices and a second set of client devices; based on the first server check, update a cache of the network access device with a status of the network server; perform, for the second set of client devices, a lookup in the cache of the network access device for the status of the network server; and based on the lookup in the cache, determine whether to initiate, for the second set of client devices, a second server check of the network server.

In another example, the disclosure is directed to a method comprising: initiating, for a first set of client devices, a first server check of a network server, wherein the network access device is configured to use the network server for the first set of client devices and a second set of client devices; based on the first server check, updating a cache of the network access device with a status of the network server; performing, for the second set of client devices, a lookup in the cache of the network access device for the status of the network server; and based on the lookup in the cache, determining whether to initiate, for the second set of client devices, a second server check of the network server.

In another example, the disclosure is directed to non-transitory computer-readable storage media comprising instructions that, when executed by processing circuitry, cause the processing circuitry to: initiate, for a first set of client devices, a first server check of a network server, wherein the network access device is configured to use the network server for the first set of client devices and a second set of client devices; based on the first server check, update a cache of the network access device with a status of the network server; perform, for the second set of client devices, a lookup in the cache of the network access device for the status of the network server; and based on the lookup in the cache, determine whether to initiate, for the second set of client devices, a second server check of the network server.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram of an example network system including network access server devices managed by a network management system, in accordance with one or more techniques of the disclosure.

FIG. 2 is a block diagram of an example network management system, in accordance with one or more techniques of the disclosure.

FIG. 3 is a block diagram of an example access point device, in accordance with one or more techniques of this disclosure.

FIG. 4 is a block diagram of an example edge device, in accordance with one or more techniques of this disclosure.

FIG. 5 is a flow chart illustrating an example operation of server management at a network access server device, in accordance with one or more techniques of this disclosure.

### DETAILED DESCRIPTION

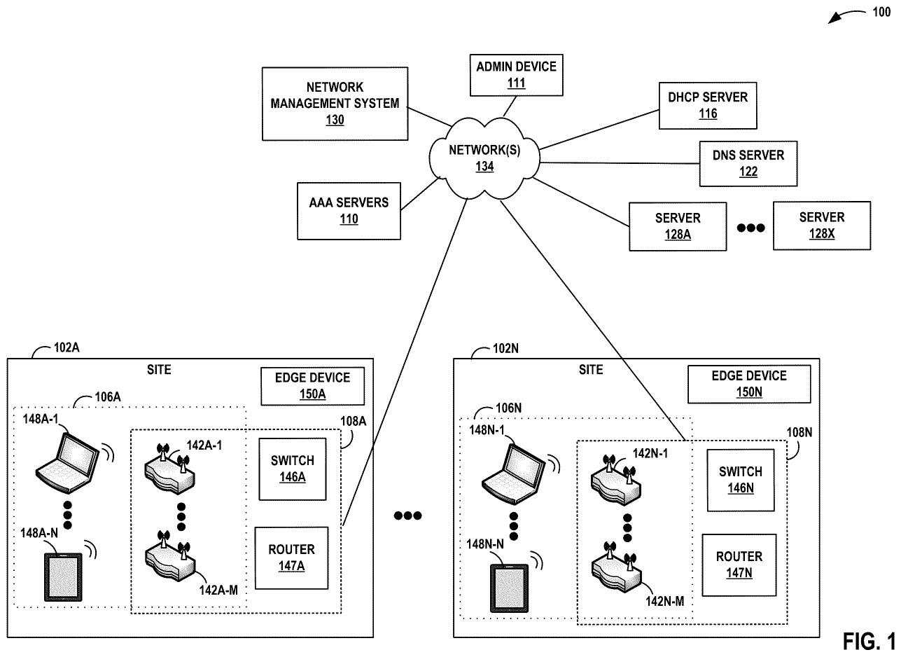

FIG. 1 is a block diagram of an example network system 100 including network access server (NAS) devices 108 managed by a network management system (NMS) 130, in accordance with one or more techniques of this disclosure. Example network system 100 includes a plurality of sites 102A-102N at which a network service provider manages one or more wireless networks 106A-106N, respectively. In some examples, one or more wireless networks 106 may be wireless local-area networks (WLANs). Although in FIG. 1 each site 102A-102N is shown as including a single wireless network 106A-106N, respectively, in some examples, each site 102A-102N may include multiple wireless networks, and the disclosure is not limited in this respect.

Each site 102A-102N includes a plurality of NAS devices 108A-108N (collectively, “NAS devices 108”), such as access points (APs) 142, switches 146, and routers 147. NAS devices may include any network infrastructure devices capable of authenticating and authorizing client devices to access an enterprise network. For example, site 102A includes a plurality of APs 142A-1 through 142A-M, a switch 146A, and a router 147A. Similarly, site 102N includes a plurality of APs 142N-1 through 142N-M, a switch 146N, and a router 147N. Each AP 142 may be any type of wireless access point, including, but not limited to, a commercial or enterprise AP, a router, or any other device that is connected to a wired network and is capable of providing wireless network access to client devices within the site. In some examples, each of APs 142A-1 through 142A-M at site 102A may be connected to one or both of switch 146A and router 147A. Similarly, each of APs 142N-1 through 142N-M at site 102N may be connected to one or both of switch 146N and router 147N.

Each site 102A-102N also includes a plurality of client devices, otherwise known as user equipment devices (UEs), referred to generally as UEs or client devices 148, representing various wireless-enabled devices within each site. For example, a plurality of UEs 148A-1 through 148A-K are currently located at site 102A. Similarly, a plurality of UEs 148N-1 through 148N-K are currently located at site 102N. Each UE 148 may be any type of wireless client device, including, but not limited to, a mobile device such as a smart phone, tablet or laptop computer, a personal digital assistant (PDA), a wireless terminal, a smart watch, smart ring, or other wearable device. UEs 148 may also include wired client-side devices, e.g., IoT devices such as printers, security devices, environmental sensors, or any other device connected to the wired network and configured to communicate over one or more wireless networks 106.

In order to provide wireless network services to UEs 148 and/or communicate over the wireless networks 106, APs 142 and the other wired client-side devices at sites 102 are connected, either directly or indirectly, to one or more network devices (e.g., switches, routers, gateways, or the like) via physical cables, e.g., Ethernet cables. Although illustrated in FIG. 1 as if each site 102 includes a single switch and a single router, in other examples, each site 102 may include more or fewer switches and/or routers. In addition, two or more switches at a site may be connected to each other and/or connected to two or more routers, e.g., via a mesh or partial mesh topology in a hub-and-spoke architecture. In some examples, interconnected switches 146 and routers 147 comprise wired local area networks (LANs) at sites 102 hosting wireless networks 106.

Example network system 100 also includes various networking components for providing networking services within the wired network including, as examples, Authentication, Authorization and Accounting (AAA) servers 110 for authenticating users and/or UEs 148, a Dynamic Host Configuration Protocol (DHCP) server 116 for dynamically assigning network addresses (e.g., IP addresses) to UEs 148 upon authentication, a Domain Name System (DNS) server 122 for resolving domain names into network addresses, a plurality of servers 128A-128X (collectively “servers 128”) (e.g., web servers, databases servers, file servers and the like), and NMS 130. As shown in FIG. 1A, the various devices and systems of network 100 are coupled together via one or more network(s) 134, e.g., the Internet and/or an enterprise intranet.

In the example of FIG. 1, NMS 130 is a cloud-based computing platform that manages wireless networks 106A-106N at one or more of sites 102A-102N. As further described herein, NMS 130 provides an integrated suite of management tools. In general, NMS 130 may provide a cloud-based platform for wireless network data acquisition, monitoring, activity logging, reporting, predictive analytics, network anomaly identification, and alert generation. In some examples, NMS 130 outputs notifications, such as alerts, alarms, graphical indicators on dashboards, log messages, text/SMS messages, email messages, and the like, and/or recommendations regarding wireless network issues to a site or network administrator (“admin”) interacting with and/or operating admin device 111. Additionally, in some examples, NMS 130 operates in response to configuration input received from the administrator interacting with and/or operating admin device 111.

The administrator and admin device 111 may comprise IT personnel and an administrator computing device associated with one or more of sites 102. Admin device 111 may be implemented as any suitable device for presenting output and/or accepting user input. For instance, admin device 111 may include a display. Admin device 111 may be a computing system, such as a mobile or non-mobile computing device operated by a user and/or by the administrator. Admin device 111 may, for example, represent a workstation, a laptop or notebook computer, a desktop computer, a tablet computer, or any other computing device that may be operated by a user and/or present a user interface in accordance with one or more aspects of the present disclosure. Admin device 111 may be physically separate from and/or in a different location than NMS 130 such that admin device 111 may communicate with NMS 130 via network 134 or other means of communication.

In some examples, one or more of NAS devices 108, e.g., APs 142, switches 146, and routers 147, may connect to edge devices 150A-150N via physical cables, e.g., Ethernet cables. Edge devices 150 comprise cloud-managed, wireless local area network (LAN) controllers. Each of edge devices 150 may comprise an on-premises device at a site 102 that is in communication with NMS 130 to extend certain microservices from NMS 130 to the on-premises NAS devices 108 while using NMS 130 and its distributed software architecture for scalable and resilient operations, management, troubleshooting, and analytics.

Each one of the network devices of network system 100, e.g., AAA servers 110, servers 116, 122 and/or 128, APs 142, switches 146, routers 147, UEs 148, edge devices 150, and any other servers or devices attached to or forming part of network system 100, may include a system log or an error log module wherein each one of these network devices records the status of the network device including normal operational status and error conditions.

Throughout this disclosure, one or more of the network devices of network system 100, e.g., servers 116, 122 and/or 128, APs 142, switches 146, routers 147, and UEs 148, may be considered “third-party” network devices when owned by and/or associated with a different entity than NMS 130 such that NMS 130 does not directly receive, collect, or otherwise have access to the recorded status and other data of the third-party network devices. In some examples, edge devices 150 may provide a proxy through which the recorded status and other data of the third-party network devices may be reported to NMS 130.

NMS 130 is configured to operate according to an artificial intelligence/machine-learning-based computing platform providing comprehensive automation, insight, and assurance (WiFi Assurance, Wired Assurance and WAN assurance) spanning from “client,” e.g., client devices 148 connected to wireless networks 106 and wired local area networks (LANs) at sites 102 to “cloud,” e.g., cloud-based application services that may be hosted by computing resources within data centers.

As described herein, NMS 130 provides an integrated suite of management tools and may provide a cloud-based platform for wireless network data acquisition, monitoring, activity logging, reporting, predictive analytics, network anomaly identification, and alert generation. For example, NMS 130 may be configured to proactively monitor and adaptively configure network 100 so as to provide self-driving capabilities.

In some examples, AI-driven NMS 130 also provides configuration management, monitoring and automated oversight of software defined wide-area networks (SD-WANs), which operate as an intermediate network communicatively coupling wireless networks 106 and wired LANs at sites 102 to data centers and application services. In general, SD-WANs provide seamless, secure, traffic-engineered connectivity between “spoke” routers (e.g., routers 147) of the wired LANs hosting wireless networks 106 of branch or campus enterprise networks, to “hub” routers further up the cloud stack toward the cloud-based application services. SD-WANs often operate and manage an overlay network on an underlying physical Wide-Area Network (WAN), which provides connectivity to geographically separate customer networks. In other words, SD-WANs extend Software-Defined Networking (SDN) capabilities to a WAN and allow network(s) to decouple underlying physical network infrastructure from virtualized network infrastructure and applications such that the networks may be configured and managed in a flexible and scalable manner.

In some examples, AI-driven NMS 130 may enable intent-based configuration and management of network system 100, including enabling construction, presentation, and execution of intent-driven workflows for configuring and managing devices associated with wireless networks 106, wired LAN networks, and/or SD-WANs. For example, declarative requirements express a desired configuration of network components without specifying an exact native device configuration and control flow. By utilizing declarative requirements, what should be accomplished may be specified rather than how it should be accomplished. Declarative requirements may be contrasted with imperative instructions that describe the exact device configuration syntax and control flow to achieve the configuration. By utilizing declarative requirements rather than imperative instructions, a user and/or user system is relieved of the burden of determining the exact device configurations required to achieve a desired result of the user/system. For example, it is often difficult and burdensome to specify and manage exact imperative instructions to configure each device of a network when various different types of devices from different vendors are utilized. The types and kinds of devices of the network may dynamically change as new devices are added, and device failures occur. Managing various different types of devices from different vendors with different configuration protocols, syntax, and software versions to configure a cohesive network of devices is often difficult to achieve. Thus, by only requiring a user/system to specify declarative requirements that specify a desired result applicable across various different types of devices, management and configuration of the network devices becomes more efficient. Further example details and techniques of an intent-based network management system are described in U.S. Pat. No. 10,756,983, entitled “Intent-based Analytics,” and U.S. Pat. No. 10,992,543, entitled “Automatically generating an intent-based network model of an existing computer network,” each of which is hereby incorporated herein by reference.

Authentication, Authorization, and Accounting (AAA) servers 110, e.g., Remote Authentication Dial-In User Service (RADIUS) servers, may authenticate client devices 148 prior to providing access to the enterprise network via the NAS devices 108. AAA servers 110 may be one example of network servers. Client devices 148 may include multiple different categories of devices with respect to a given enterprise, such as trusted enterprise devices, bring-your-own-device (BYOD) devices, IoT devices, and guest devices.

In general, this disclosure describes one or more techniques for a NAS device (e.g., AP 142A-1) of NAS devices 108 to maintain a cache that stores statuses associated with network servers, e.g., AAA servers 110, configured for AP 142A-1. In accordance with the disclosed techniques, based on the statuses stored in the cache, AP 142A-1 may propagate failover and/or fallback across WLANs 106 and across frequency bands supported by AP 142A-1. In this way, the disclosed techniques avoid redundant server checks and facilitate proactive AAA server failover and/or fallback across multiple sets of supported client devices 148, e.g., sets of client devices corresponding to BSSes, WLANs 106, and/or frequency bands at AP 142A-1.

In some examples, a BSS may be a band specific SSID that organizes (e.g., groups, configures, etc.) a set of client devices operating on a specific frequency band. In some examples, a WLAN may include one or more BSSes. For instance, a WLAN may include three BSSes each operating on one of frequency bands 2.4 GHz, 5 GHz, and/or 6 GHz. In some examples, propagation of failover and/or fallback across a WLAN managed by AP 142A-1 may propagate failover and/or fallback across one or more BSSes of the WLAN.

AP 142A-1 may support multiple BSSes or WLANs 106 on each of one or more frequency bands (e.g., 2.4 GHz, 5 GHz, and/or 6 GHz). AP 142A-1 may be configured with a set of AAA servers of AAA servers 110 for each BSS or WLAN at each frequency band supported by AP 142A-1. For example, the set of AAA servers may include a primary AAA server that is preferably used for authentication and accounting requests for the BSS and a secondary AAA server that is used in the case of failure of the primary AAA server. In order to facilitate proactive AAA server failover and fallback, AP 142A-1 periodically performs a server check of an AAA server of AAA servers 110 by sending one or more authentication or accounting requests to the AAA server, and stores a status, e.g., reachable and/or available, of the AAA server in a local cache. If an AAA server configured for a BSS is unreachable and/or unavailable, AP 142A-1 will failover or fallback to another AAA server in the set of the AAA servers configured for the BSS and, based on the cache, propagate the failover or fallback to other BSSes supported by AP 142A-1 that are configured with the same set of AAA servers.

In accordance with the disclosed techniques, AP 142A-1 may include a cache to store the reachability and availability status of each AAA server of the set of AAA servers configured for the BSSes supported by AP 142A-1. Prior to initiating a server check of an AAA server of the set of AAA servers 110, AP 142A-1 may perform a lookup of the AAA server in the cache to determine whether a server check is needed. For example, after failover from a primary AAA server to a secondary AAA server, AP 142A-1 may perform a lookup in the cache for a status of the primary AAA server and determine that the primary AAA server has a positive status (e.g., the primary AAA server is reachable and available) causing AP 142A-1 to not perform another server check of the primary AAA server. In this example, AP 142A-1 may initiate a fallback from the secondary AAA server to the primary AAA server. In another example, after failover from a primary AAA server to a secondary AAA server, AP 142A-1 may perform a lookup in the cache for the status of the primary AAA server and determine that the primary AAA server has a negative status (e.g., unreachable and/or unavailable) causing AP 142A-1 to perform a server check of the primary AAA server.

In some examples, performing server checks of the same AAA servers for multiple BSSes configured with the same set of AAA servers may be redundant and result in inefficiencies and an increased network load. For example, a first and second BSS of AP 142A-1 may be configured with the same set of primary and secondary AAA servers. Conventionally, AP 142A-1 may perform a server check for the first BSS of the primary AAA server and also perform a server check for the second BSS of the same primary AAA server, which is redundant and unnecessary. In another example, when AP 142A-1 performs a failover or a fallback to another AAA server in the set of AAA servers configured for the first BSS, conventionally, AP 142A-1 independently determines whether to failover or fallback for the second BSS and any other BSSes configured with the same set of AAA servers, which may again result in increased network workload and inefficiencies. For example, a primary AAA server associated with the first BSS may be unavailable resulting in a failover to a secondary AAA server and de-authentication of a client device connected to the BSS. If the failover is not propagated to the other BSSes associated with the primary AAA server, then client devices connected to each of those other BSSes may also be de-authenticated.

The techniques of this disclosure provide one or more technical advantages and practical applications. For example, the techniques enable AP 142A-1 to maintain a cache that stores statuses of AAA servers and based on the statuses stored in the cache, facilitate proactive failover and/or fallback across WLANs and across frequency bands supported by AP 142A-1. For example, AP 142A-1 may perform a lookup in the cache for a status of a primary AAA server configured for a BSS. Based on the lookup, AP 142A-1 may determine that a server check of the primary AAA server is required. AP 142A-1 may perform the server check and determine that the primary AAA server has a negative status (e.g., the primary AAA server is unreachable and/or unavailable). AP 142A-1 may update the cache to mark the status of the primary AAA server as negative and then failover to the secondary AAA server for that BSS. AP 142A-1 may then propagate the failover based on the updated statuses in the cache across BSSes supported by AP 142A-1. In this way, AP 142A-1 proactively causes the other BSSes to failover to the secondary AAA server. AP 142A-1 may function similarly for fallback to the primary AAA server once the primary AAA server is reachable and available. In this way, techniques of this disclosure potentially avoid redundant server checks on AAA servers 110 configured for multiple BSSes and facilitate propagation of AAA server failover and fallback across BSSes, such that network loads may be reduced and efficiency may be increased.

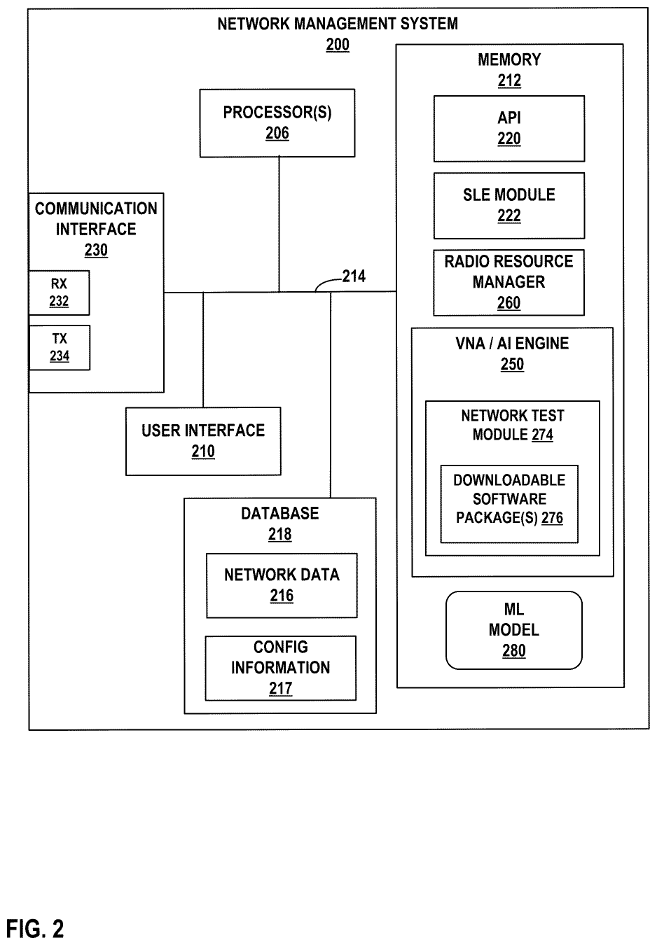

FIG. 2 is a block diagram of an example network management system (NMS) 200, in accordance with one or more techniques of the disclosure. NMS 200 may be used to implement, for example, NMS 130 in FIG. 1. In such examples, NMS 200 is responsible for monitoring and management of one or more wireless networks 106A-106N at sites 102A-102N, respectively.

NMS 200 includes a communications interface 230, one or more processor(s) 206, a user interface 210, a memory 212, and a database 218. The various elements are coupled together via a bus 214 over which the various elements may exchange data and information. In some examples, NMS 200 receives data from one or more of client devices 148, APs 142, switches 146, routers, 147, edge devices 150, and other network nodes within network 134, e.g., routers and gateway devices, which may be used to calculate one or more SLE metrics and/or update network data 216 in database 218. NMS 200 analyzes this data for cloud-based management of wireless networks 106A-106N. In some examples, NMS 200 may be part of another server shown in FIG. 1A or a part of any other server.

Processor(s) 206 execute software instructions, such as those used to define a software or computer program, stored to a computer-readable storage medium (such as memory 212), such as non-transitory computer-readable mediums including a storage device (e.g., a disk drive, or an optical drive) or a memory (such as Flash memory or RAM) or any other type of volatile or non-volatile memory, that stores instructions to cause the one or more processors 206 to perform the techniques described herein.

Communications interface 230 may include, for example, an Ethernet interface. Communications interface 230 couples NMS 200 to a network and/or the Internet, such as any of network(s) 134 as shown in FIG. 1A, and/or any local area networks. Communications interface 230 includes a receiver 232 and a transmitter 234 by which NMS 200 receives/transmits data and information to/from any of client devices 148, APs 142, switches 146, routers 147, edge devices 150, servers 116, 122, 128 and/or any other network nodes, devices, or systems forming part of network system 100 such as shown in FIG. 1. In some scenarios described herein in which network system 100 includes “third-party” network devices that are owned and/or associated with different entities than NMS 200, NMS 200 does not directly receive, collect, or otherwise have access to network data from the third-party network devices. In some examples, an edge device, such as edge devices 150 from FIG. 1 may provide a proxy through which the network data of the third-party network devices may be reported to NMS 200.

The data and information received by NMS 200 may include, for example, telemetry data, SLE-related data, or event data received from one or more of client device APs 148, APs 142, switches 146, routers 147, edge devices 150, or other network nodes, e.g., routers and gateway devices, used by NMS 200 to remotely monitor the performance of wireless networks 106A-106N and application sessions from client device to cloud-based application server. NMS 200 may further transmit data via communications interface 230 to any of the network devices, such as client devices 148, APs 142, switches 146, routers 147, edge devices 150, or other network nodes within network 134, to remotely manage wireless networks 106A-106N and portions of the wired network.

Memory 212 includes one or more devices configured to store programming modules and/or data associated with operation of NMS 200. For example, memory 212 may include a computer-readable storage medium, such as a non-transitory computer-readable medium including a storage device (e.g., a disk drive, or an optical drive) or a memory (such as Flash memory or RAM) or any other type of volatile or non-volatile memory, that stores instructions to cause the one or more processor(s) 206 to perform the techniques described herein.

In this example, memory 212 includes an API 220, a SLE module 222, a virtual network assistant (VNA)/AI engine 250, and a radio resource management (RRM) engine 260. NMS 200 may also include any other programmed modules, software engines and/or interfaces configured for remote monitoring and management of wireless networks 106A-106N and portions of the wired network, including remote monitoring and management of any of APs 142, switches 146, routers 147, edge devices 150, or other network devices, e.g., routers and gateway devices.

SLE module 222 enables set up and tracking of thresholds for SLE metrics for each network 106A-106N. SLE module 222 further analyzes SLE-related data collected by, e.g., APs, such as any of APs 142 from UEs in each wireless network 106A-106N. For example, APs 142A-1 through 142A-N collect SLE-related data from UEs 148A-1 through 148A-N currently connected to wireless network 106A. This data is transmitted to NMS 200, which executes SLE module 222 to determine one or more SLE metrics for each UE 148A-1 through 148A-N currently connected to wireless network 106A. This data, in addition to any network data collected by one or more APs 142A-1 through 142A-N in wireless network 106A, is transmitted to NMS 200 and stored as, for example, network data 216 in database 218.

RRM engine 260 monitors one or more metrics for each site 102A-102N in order to learn and optimize the RF environment at each site. For example, RRM engine 260 may monitor the coverage and capacity SLE metrics for a wireless network 106 at a site 102 in order to identify potential issues with SLE coverage and/or capacity in the wireless network 106 and to make adjustments to the radio settings of the access points at each site to address the identified issues. For example, RRM engine may determine channel and transmit power distribution across all APs 142 in each network 106A-106N. For example, RRM engine 260 may monitor events, power, channel, bandwidth, and number of clients connected to each AP. RRM engine 260 may further automatically change or update configurations of one or more APs 142 at a site 102 with an aim to improve the coverage and capacity SLE metrics and thus to provide an improved wireless experience for the user.

VNA/AI engine 250 analyzes data received from network devices as well as its own data to identify when undesired to abnormal states are encountered at one of the network devices. For example, VNA/AI engine 250 may identify the root cause of any undesired or abnormal states, e.g., any poor SLE metric(s) indicative of connected issues at one or more network devices. In addition, VNA/AI engine 250 may automatically invoke one or more corrective actions intended to address the identified root cause(s) of one or more poor SLE metrics. In some examples, ML model 280 may comprise a supervised ML model that is trained, using training data comprising pre-collected, labeled network data received from the network devices. The supervised ML model may comprise one of a logistical regression, naïve Bayesian, support vector machine (SVM), or the like. In other examples, ML model 280 may comprise an unsupervised ML model. Although not shown in FIG. 2, in some examples, database 218 may store the training data and VNA/AI engine 250 or a dedicated training module may be configured to train ML model 280 based on the training data to determine appropriate weights across the one or more features of the training data.

Examples of corrective actions that may be automatically invoked by VNA/AI engine 250 may include, but are not limited to, invoking RRM 260 to reboot one or more APs, adjusting/modifying the transmit power of a specific radio in a specific AP, adding SSID configuration to a specific AP, changing channels on an AP or a set of APs, etc. The corrective actions may further include restarting a switch and/or a router, invoking downloading of new software to an AP, switch, or router, etc. These corrective actions are given for example purposes only, and the disclosure is not limited in this respect. If automatic corrective actions are not available or do not adequately resolve the root cause, VNA/AI engine 250 may proactively provide a notification including recommended corrective actions to be taken by IT personnel, e.g., a site or network administrator using admin device 111, to address the network error.

In one example, NMS 200 may include an application (e.g., a primary alternate contingency emergency (PACE) application) which may include a list of AAA servers configured for one of NAS devices 108. In one example, a user may configure AAA servers 110 for one or more NAS devices 108 by updating/modifying the list of AAA servers in the PACE application. NMS 200 may push the list of AAA servers to a corresponding NAS device to configure the AAA servers for that NAS device. For example, AP 142A-1 may be configured with three AAA servers. A user may modify the configuration of AP 142A-1 by updating the list of AAA servers included in the PACE application to only include two AAA servers. NMS 200 may push the list of AAA servers to AP 142A-1 such that the configuration of AP 142A-1 may be updated to include only two AAA servers.

In one example, the PACE application may convert the list of AAA servers into a list of IP addresses and push the first available IP address to AP 142A-1. In this instance, the first available IP address may represent a preferable (e.g., primary) AAA server for AP 142A-1. The PACE application may update the list of AAA servers based on any AAA server related configuration changes or events obtained from AP 142A-1.

In one example, a user and/or admin associated with NMS 200 may obtain near real time information from the PACE application. For example, an administrator may request a list of AAA servers configured for AP 142A-1 from NMS 200. NMS 200 may provide the administrator with the list of AAA servers configured for AP 142A-1 from the PACE application. For instance, NMS 200 may provide the administrator with the following list of AAA servers configured for a WLAN 106 associated with AP 142A-1. The following information includes identification of the active server and a corresponding server list for each of authentication services and accounting services. Each server may include priority (e.g., 0, 1, 2, etc.), id (identification), IP (internet protocol) address, and status information (e.g., available, reachable, etc.). In some examples, the lowest numerical value priority may indicate the primary (e.g., preferred) server. For instance, a priority of 0 may indicate the primary server, a priority of 1 may indicate the secondary server, and a priority of 2 may indicate the tertiary server. In some examples, the priority of 0 may indicate an active server that AP 142A-1 is configured to use for a first set of client devices of WLAN 106. In some examples, NMS 200 may provide the administrator with additional information from the PACE application. For instance, NMS 200 may provide the administrator with one or more timestamps indicating when the server list was updated (e.g., checked, refreshed, etc.) and/or one or more timestamps indicating when the server list will be next updated.

### Authentication Server Info

LATEST SERVER LIST ACTION=Server (Re)configuration occurred at 2025-02-27 12:14:50.65179638+0000 UTC m=+47.978214001
Active server: name 192.168.1.10 priority 0 id 50 ip 192.168.1.10 AVAILABLE and REACHABLE

### Server List in Pace

0: name 192.168.1.10 priority 0 id 50 ip 192.168.1.10 AVAILABLE and REACHABLE
1: name 192.168.1.3 priority 1 id 51 ip 192.168.1.3 AVAILABLE and REACHABLE
2: name home.bbrouter priority 2 id 52 ip 192.168.1.9 AVAILABLE and REACHABLE

### Accounting Server Info

LATEST SERVER LIST ACTION =Server (Re)configuration occurred at 2025-02-27 12:15:00.658390167+0000 UTC m=+57.984807648
Active server: name 192.168.1.10 priority 0 id 53 ip 192.168.1.10 AVAILABLE and REACHABLE

### Server List in Pace

0: name 192.168.1.10 priority 0 id 53 ip 192.168.1.10 AVAILABLE and REACHABLE
1: name 192.168.1.3 priority 1 id 54 ip 192.168.1.3 AVAILABLE and REACHABLE
Next periodic server refresh action scheduled at 2025-03-12 08:40:34.2445505+0000 UTC m=+653.989357769

A NAS device may perform a server check by sending one or more authentication or accounting requests to an AAA server to obtain a status (e.g., reachable and/or available) of the AAA server. The authentication and/or accounting requests may be associated with either or both of actual requests for real client devices at a site or test requests for simulated client devices at the site. In accordance with one or more techniques of this disclosure, a NAS device may maintain a cache that stores the statuses associated with AAA servers 110 configured for the NAS device. In accordance with the disclosed techniques, the cache enables proactive AAA server failover and/or fallback across supported BSSes at the NAS device.

In one example, VNA/AI engine 250 includes network test module 274 which includes downloadable software packages 276. In one example, to perform a server check, network test module 274 is configured to select and/or provide a downloadable software package 276 to one or more NAS devices, such as AP 142A-1, to enable AP 142A-1 to simulate a network instance to obtain the status of an AAA server. NMS 200 may receive the data indicative of the server check of the network instance from AP 142A-1 as part of network data 216, NMS 200 may analyze the data to determine if the AAA server is reachable and/or available.

In one example, AP 142A-1 may initiate a server check and NMS 200 may select a software package from downloadable software packages 276, wherein the selected software package includes instructions for simulating a client device such that the simulated client device requests authentication or accounting with an AAA server. NMS 200 may then send the selected software package to AP 142A-1 to cause AP 142A-1 to simulate the client device. NMS 200 may then obtain the data from AP 142A-1 indicative of the authentication or accounting request for the simulated client device with the AAA server.

In some examples, each of downloadable software packages 276 includes one or more of an authentication or accounting request to be performed by the simulated network instance, configuration data for a communication channel to be established with NMS 200 for transmitting authentication or accounting request test data, a schedule to perform the server checks, a Virtual Local Area Network (VLAN) to be used during performance of the server checks, or one or more resource requirements to be applied during performance the server checks. Downloadable software packages 276 may include instructions for causing a NAS device to perform a server check. For example, downloadable software package 276 may include instructions for causing AP 142A-1 to perform a server check by simulating a network instance that attempts an authentication or accounting request with an AAA server. Network test module 274 may send to AP 142A-1 (or AP 142A-1 obtains from network test module 274), the selected software package to cause AP 142A-1 to simulate a network instance, e.g., a client device, to obtain data indicative of a status of an AAA server. Although server checks are described in some examples as being performed by a network instance of an AP, server checks may be performed by other network instances of other devices, such as switches, routers, or edge devices.

Further example details and techniques of simulating a network instance to obtain data indicative of performance of the network instance is described in India Provisional Application No. 202441038170, entitled “Downloadable Network Tests For Virtual Clients Functions,” and U.S. application Ser. No. 18/927,637, entitled “Network Authentication and Authorization Issue Detection” both of which are hereby incorporated herein by reference.

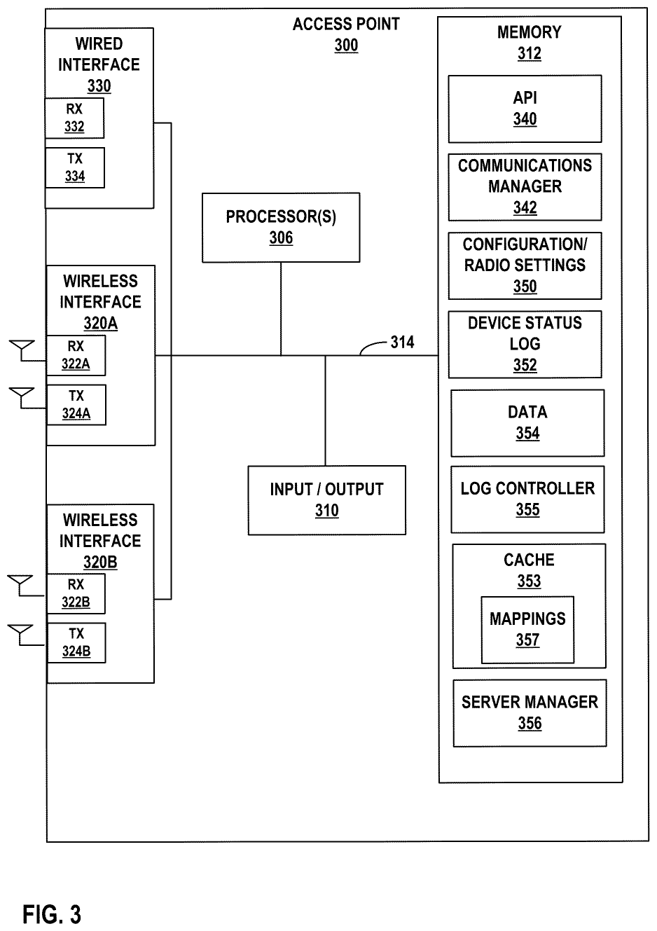

FIG. 3 is a block diagram of an example access point (AP) device 300, in accordance with one or more techniques of this disclosure. Example access point 300 shown in FIG. 3 may be used to implement any of APs 142 as shown and described herein with respect to FIG. 1. Access point 300 may comprise, for example, a Wi-Fi, Bluetooth and/or Bluetooth Low Energy (BLE) base station or any other type of wireless access point.

In the example of FIG. 3, access point 300 includes a wired interface 330, wireless interfaces 320A-320B one or more processor(s) 306, memory 312, and input/output 310, coupled together via a bus 314 over which the various elements may exchange data and information. Wired interface 330 represents a physical network interface and includes a receiver 332 and a transmitter 334 for sending and receiving network communications, e.g., packets. Wired interface 330 couples, either directly or indirectly, access point 300 to a wired network device, such as one of switches 146 or routers 147 of FIG. 1 within the wired network via a cable, such as an Ethernet cable.

First and second wireless interfaces 320A and 320B represent wireless network interfaces and include receivers 322A and 322B, respectively, each including a receive antenna via which access point 300 may receive wireless signals from wireless communications devices, such as UEs 148 of FIG. 1. First and second wireless interfaces 320A and 320B further include transmitters 324A and 324B, respectively, each including transmit antennas via which access point 300 may transmit wireless signals to wireless communications devices, such as UEs 148 of FIG. 1. In some examples, first wireless interface 320A may include a Wi-Fi 802.11 interface (e.g., 2.4 GHz and/or 5 GHz) and second wireless interface 320B may include a Bluetooth interface and/or a Bluetooth Low Energy (BLE) interface.

Processor(s) 306 are programmable hardware-based processors configured to execute software instructions, such as those used to define a software or computer program, stored to a computer-readable storage medium (such as memory 312), such as non-transitory computer-readable mediums including a storage device (e.g., a disk drive, or an optical drive) or a memory (such as Flash memory or RAM) or any other type of volatile or non-volatile memory, that stores instructions to cause the one or more processors 306 to perform the techniques described herein.

Memory 312 includes one or more devices configured to store programming modules and/or data associated with operation of access point 300. For example, memory 312 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processor(s) 306 to perform the techniques described herein.

In this example, memory 312 stores executable software including an application programming interface (API) 340, a communications manager 342, configuration settings 350, a device status log 352, data storage 354, log controller 355, cache 353, and server manager 356. Device status log 352 includes a list of events specific to access point 300. The events may include a log of both normal events and error events such as, for example, memory status, reboot or restart events, crash events, cloud disconnect with self-recovery events, low link speed or link speed flapping events, Ethernet port status, Ethernet interface packet errors, upgrade failure events, firmware upgrade events, configuration changes, etc., as well as a time and date stamp for each event. Log controller 355 determines a logging level for the device based on instructions from NMS 130. Data 354 may store any data used and/or generated by access point 300, including data collected from UEs 148, such as data used to calculate one or more SLE metrics, that is transmitted by access point 300 for cloud-based management of wireless networks 106A by NMS 130/300.

Input/output (I/O) 310 represents physical hardware components that enable interaction with a user, such as buttons, a display, and the like. Although not shown, memory 312 typically stores executable software for controlling a user interface with respect to input received via I/O 310. Communications manager 342 includes program code that, when executed by processor(s) 306, allow access point 300 to communicate with UEs 148 and/or network(s) 134 via any of interface(s) 330 and/or 320A-320C. Configuration settings 350 include any device settings for access point 300 such as radio settings for each of wireless interface(s) 320A-320C. In some examples, configuration settings 350 may include a list of network servers, e.g., AAA servers, configured for AP 300. In some examples, the list of network servers may be arranged, organized, or otherwise indicate an ordered preference of the network servers, such as a primary AAA server as a preferred AAA server to which AP 300 sends authentication and/or accounting requests and at least one secondary AAA server to which AP 300 may failover in the event the primary AAA is unreachable and/or unavailable. These settings may be configured manually or may be remotely monitored and managed by NMS 130 to optimize wireless network performance on a periodic (e.g., hourly or daily) basis.

As described herein, AP device 300 may measure and report network data from status log 352 to NMS 130. The network data may comprise event data, telemetry data, and/or other SLE-related data. The network data may include various parameters indicative of the performance and/or status of the wireless network. The parameters may be measured and/or determined by one or more of the UE devices and/or by one or more of the APs in a wireless network. NMS 130/300 may determine one or more SLE metrics based on the SLE-related data received from the APs in the wireless network and store the SLE metrics as network data.

In general, this disclosure describes one or more techniques for a NAS device (e.g., AP 300) to maintain cache 353 that stores statuses associated with network servers, e.g., AAA servers, configured for AP 300. In accordance with the disclosed techniques, cache 353, via server manager 356, enables propagation of failover and/or fallback across BSSes and frequency bands managed by AP 300. In this way, the disclosed techniques avoid redundant server checks and facilitate proactive AAA server failover and/or fallback across supported BSSes at AP 300.

AP 300 may support multiple BSSes or WLANs on each of one or more frequency bands (e.g., 2.4 GHz, 5 GHz, and/or 6 GHz). AP 300 may be configured with a set of AAA servers for each BSS or WLAN at each frequency band supported by AP 300. For example, the set of AAA servers may include a primary AAA server that is preferably used for authentication and accounting requests for the BSS and a secondary AAA server that is used in the case of failure of the primary AAA server. In some examples, the primary AAA server may include more memory, more processing power, and/or reduced authentication latency compared to the secondary AAA server. The primary server may be a first point of contact for handling authentication, authorization, or accounting requests and the secondary server may act as a backup to the primary server.

In one example, failover may be the process of switching to an alternative server when a primary server fails to respond. In another example, fallback may be the process of returning to the primary server after the primary server becomes operational again. Failover may be the pre-requisite for fallback to occur.

To facilitate proactive AAA server failover and fallback, server manager 356 may periodically or continuously perform a server check of an AAA server by sending one or more authentication or accounting requests to the AAA server, and storing a status based on the authentication or accounting request, e.g., reachable and/or available, of the AAA server in cache 353. The authentication and/or accounting requests may be associated with either or both of actual requests for real client devices at a site or test requests for simulated client devices at the site. In one example, to perform a test request AP 300 may receive a downloadable software package 276 to simulate a network instance to obtain the status of an AAA server.

If an AAA server configured for a BSS is unreachable and/or unavailable, server manager 356 may update the status of the AAA server in cache 353. AP 300 may perform a failover or fallback for the BSS to another AAA server in the set of the AAA servers configured for the BSS and, based on cache 353, AP 300 may propagate the failover or fallback to other BSSes supported by AP 300 that are configured with the same set of AAA servers.

In one example, cache 353 may store the reachability and availability status of each AAA server of the set of AAA servers configured for BSSes supported by AP 300. For instance, AP 300 may support three BSSes. The first BSS may be configured with a first set of AAA servers, the second BSS may be configured with the first set of AAA servers (e.g., the same AAA servers as the first BSS), and a third BSS may be configured with a second set of AAA servers (e.g., one or more different AAA servers than the first and second BSSes). Each set of AAA servers may include one or more AAA servers. In some examples, the listing of the AAA servers of each set of AAA servers may indicate a priority of the AAA servers. For instance, a first AAA server of the set of AAA servers may be the primary AAA server, while the second AAA server of the set of AAA servers may be the secondary AAA server.

Prior to initiating a server check of an AAA server of the set of AAA servers, server manager 356 may perform a lookup of the AAA server in cache 353 to determine whether a server check is needed. For instance, server manager 356 may perform a lookup of a status of a first AAA server from the first set of AAA servers in cache 353. In one example, if a cache hit occurs and the status of the first AAA server is positive (e.g., the first AAA server is reachable and available), server manager 356 may not perform a server check of the first AAA server. In another example, if a cache hit occurs but the status of the first AAA server is negative (e.g., the first AAA server is unreachable and/or unavailable) then server manager 356 may perform a server check of the first AAA server. In some examples, if a cache miss occurs (e.g., there is no status of the first AAA server) then server manager 356 may perform a server check of the first AAA server.

In some examples, when server manager 356 performs a server check for an AAA server, server manager 356 may update cache 353 with the status of the AAA server from the most recent server check. In one example, when server manager 356 updates the status of an AAA server in cache 353, server manager 356 may also update a timestamp of the cache entry to reflect the time that the server check of the AAA server was performed.

In one example, cache 353 may comprise an authentication server cache. The authentication server cache may include information associated with an authentication server of AAA servers, e.g., AAA servers 110 of FIG. 1. In some examples, the authentication server cache may include IP (internet protocol) address, status (e.g., reachable, available, etc.), and timestamp information associated with one or more authentication servers as follows.
192.168.1.3:1812[**** of 9 len]=Available=true, Reachable=true|Last updated time 2025-02-27 12:15:10.801790339+0000 UTC m=+68.128207840, Entry removal time (due to inactivity)=2025-02-27 12:45:10.801790339+0000 UTC m=+1868.128207840
192.168.1.9:1812[**** of 9 len]=Available=true, Reachable=true|Last updated time 2025-02-27 12:15:10.729499523+0000 UTC m=+68.055917044, Entry removal time (due to inactivity)=2025-02-27 12:45:10.729499523+0000 UTC m=+1868.055917044
192.168.1.10:1812[**** of 9 len]=Available=true, Reachable=true|Last updated time 2025-02-27 12:15:10.801730058+0000 UTC m=+68.128147559, Entry removal time (due to inactivity)=2025-02-27 12:45:10.801730058+0000 UTC m=+1868.128147559

In another example, cache 353 may comprise an accounting server cache. The accounting server cache may include information associated with an accounting server of AAA servers, e.g., AAA servers 110 of FIG. 1. In some examples, the accounting server cache may include IP address, status (e.g., reachable, available, etc.), and timestamp information associated with one or more accounting servers as follows.
192.168.1.3:1813[**** of 9 len]=Available=true, Reachable=true|Last updated time 2025-02-27 12:15:10.802606793+0000 UTC m=+68.129024274, Entry removal time (due to inactivity)=2025-02-27 12:45:10.802606793+0000 UTC m=+1868.129024274
192.168.1.10:1813[**** of 9 len]=Available=true, Reachable=true|Last updated time 2025-02-27 12:15:10.802557573+0000 UTC m=+68.128975074, Entry removal time (due to inactivity)=2025-02-27 12:45:10.802557573+0000 UTC m=+1868.128975074

In some examples, the timestamps (e.g., updated time 2025-02-27 12:15:10.802557573+0000 UTC m=+68.128975074, Entry removal time (due to inactivity)=2025-02-27 12:45:10.802557573+0000 UTC m=+1868.128975074) may indicate when the information in the cache associated with the server was updated (e.g., checked, refreshed, etc.), why the information was updated, when the information will be removed, and why the information will be removed. In one example, based on the timestamp, server manager 356 may determine if a server check of the corresponding AAA server should be performed. For instance, if the timestamp associated with an AAA server status indicates that an amount of time greater than a threshold amount of time has passed, server manager 356 may perform a server check of the corresponding server.

In one example, server manager 356 may perform a lookup in cache 353 for a primary AAA server configured for a BSS. Based on the lookup, server manager 356 may determine that a server check of the primary AAA server is required. Server manager 356 may perform the server check and determine that the primary AAA has a negative status (e.g., the primary AAA server is unreachable and/or unavailable). Server manager 356 may update cache 353 to mark the status of the primary AAA server as negative and then AP 300 may determine that a failover to the secondary AAA server for that BSS may be needed. In some examples, before AP 300 performs a failover to the secondary AAA server for the BSS, AP 300 may perform a lookup in cache 353 for the status of the secondary AAA server or determine the status of the secondary AAA server by performing a server check of the secondary AAA server. If the status of the secondary AAA server has a positive status (e.g., the secondary AAA server is reachable and available) then AP 300 may perform a failover to the secondary AAA server for the BSS. Server manager 346 may then propagate the failover based on the updated statuses in cache 353 across BSSes supported by AP 300 that are configured with the same primary AAA server. In this way, based on the updated cache, server manager 356 will proactively failover to the secondary AAA server for other BSSes configured with the same set of AAA servers.

In one example, server manager 356 may perform a lookup in cache 353 for the primary AAA server configured for the BSS. Based on the lookup, server manager 356 may determine that a server check of the primary AAA server is required. Server manager 356 may perform the server check and determine that the primary AAA has a positive status (e.g., the primary AAA server is reachable and available). Server manager 356 may update cache 353 to mark the status of the primary AAA server as positive and then AP 300 may perform a fallback to the primary AAA server for that BSS. Server manager 346 may then propagate the fallback based on the updated statuses in cache 353 across BSSes supported by AP 300. In this way, based on the updated cache, server manager 356 will proactively fallback to the primary AAA server for other BSSes configured with the same set of AAA servers.

In some examples, cache 353 may include mappings 357. In other examples, one or more other components of AP 300, such as configuration/radio settings 350, may include mappings 357. Mappings 357 may include one or more mappings of BSSes or WLANs of AP 300 to active radius servers. An active radius server may be a radius server with a positive status (e.g., a radius server that is currently operational). In one example, mappings 357 may be managed by server manager 356 or NMS 130. For instance, server manager 356 and/or NMS 130 may update mappings 357 based on one or more server statuses stored in cache 353.

In a first instance, an example mapping of an active (e.g., positive status) AAA server may include the following.
192.168.1.10:1812==>wl2.4, wl2.2, wl2.5, wl2.8, wl1.9, wl2.10, wl1.2, wl1.7, wl2.9, wl2.7, wl2.1, wl1.1, wl1.4, wl1.5, wl1.6, wl2.3, wl1.8, wl1.3, wl2.6, wl1.10

In a second instance, an example mapping of an active AAA server may include the following. p1 192.168.1.10:1813==>wl1.4, wl2.1, wl2.7, wl1.10, wl2.4, wl1.5, wl1.6, wl2.3, wl2.10, wl1.9, wl1.1, wl1.8, wl1.3, wl2.2, wl1.7, wl2.9, wl1.2, wl2.5, wl2.6, wl2.8

In both instances, the mappings may include an IP address of the AAA server and the one or more WLANs that use the AAA server. In both instances, each AAA server may be mapped to a plurality of WLANs across different frequency channels. Each WLAN may be represented by “W1x. y,” where the “x” may represent the WLAN itself and the “y” may represent the frequency channel that the WLAN is operating on.

In one example, to propagate a failover or fallback associated with AP 300, server manager 356 may determine, based on updated status cache 353, the AAA server that has triggered the failover or fallback (e.g., the AAA server with the negative status). Server manager 353 may then determine, based on one or more of mappings 357, the WLANs and/or BSSes associated with the AAA server that triggered the failover or fallback. In this way, AP 300 may proactively propagate the failover or fallback to any WLANs and/or BSSes that are associated with the AAA server that triggered the failover or fallback. In some examples, once AP 300 has proactively caused one or more WLANs and/or BSSes to failover or fallback, server manager 356 may update mappings 357.

In one example, AP 300 may support three BSSes. The first BSS may be configured with a first set of AAA servers, the second BSS may be configured with the first set of AAA servers (e.g., the same AAA servers as the first BSS), and a third BSS may be configured with a second set of AAA servers (e.g., one or more different AAA servers than the first and second BSSes). In one instance, server manager 356 may update the status in cache 353 of the primary server of the first set of AAA servers to negative and failover to a secondary AAA server of the first set of AAA servers for the first BSS. Server manager 356 may, based on the negative status of the primary server of the first set of AAA servers and one or more of mappings 357, propagate the failover to any BSSes operating with the same primary AAA server. For instance, server manager 356 may propagate the failover to the second BSS which is configured with the same set of AAA servers as the first BSS. Similarly, if AP 300 performs a fallback to the primary AAA server for the first BSS, server manager 356 may, based on mappings 357 and cache 353, propagate the fallback to any BSSes operating with the same set of AAA servers (e.g., the second BSS).

In one example, if a failover occurs for a BSS of AP 300, server manager 356 may propagate the failover to BSSes of AP 300 configured to use primary AAA servers having the same Internet Protocol (IP) address as the faulty primary AAA server. In one example, if a fallback to a primary AAA server occurs for the BSS of AP 300, server manager 356 may propagate the fallback to BSSes of AP 300 configured with primary AAA servers having the same IP address as the now active primary AAA server.

In some examples, once AP 300 performs a failover, server manager 356 may spawn a go-routine to periodically (e.g., based on a fallback check period) issue server checks of the primary AAA server. In one example, server checks to determine reachability and availability of the primary AAA server may be associated with either or both of actual authentication or accounting requests for real client devices at the site or test authentication or accounting request for simulated client devices at the site. In some examples, server checks may include the password and port number configured by the user for the actual or test authentication or accounting requests.

If a reject is received for an authentication test request and an accounting response is received for an accounting request, then the corresponding AAA server may be available. If the corresponding AAA server is not available, server manager 356 may continue to perform the go-routine until the corresponding AAA server is reached. In one example, primary server fallback may be disabled by default and may be kicked off only when failover occurs and primary server fallback is enabled. If failover does not occur, then the go-routine to check the availability of a primary AAA server may not run.

In one example, a user may configure AAA servers via a user interface (UI). For example, the user may choose a primary AAA server. The AAA server may be configured as the IP address or Fully Qualified Domain Name (FQDN). If the primary AAA server is configured as FQDN then the first IP address returned in FQDN resolution will be treated as a primary server. An application (e.g., a primary alternate contingency emergency (PACE) application) of NMS 200 may maintain a list of AAA servers and to prevent duplicate entries of the AAA servers in the list, a check may be configured to skip the AAA server entry if the IP address is already in the list.

In one example, upon client connection, initial authentication may occur on the user selected primary AAA server. In one example, a user may need an updated list of the AAA servers. In such an example, the user may select an option via the UI to refresh the list of AAA servers. AP 300 may obtain a server list refresh action from NMS 200 such that server manager 356 may perform a server check of the AAA servers irrespective of the status of the AAA servers. In one example, based on one or more server checks, the list of AAA servers may then be updated on the UI.

Server manager 356 may send updates or events (e.g., associated AP 300 performing a failover or fallback) to NMS 200. For instance, if server manager 356 updates cache 353 to indicate a positive status for a primary AAA server of a BSS of AP 300, an event may be sent to NMS 200 such that a corresponding list of AAA servers may be re-arranged. In one example, the list of AAA servers stored in the PACE application of NMS 200 may be re-arranged such that the primary AAA server (as opposed to a secondary AAA server) is indicated as the preferable AAA server for AP 300.

Based on events from a user or AP 300, the PACE application may be configured by NMS 200, to generate a list of AAA servers that indicates a priority of AAA servers configured for AP 300. For instance, the PACE application may consider a server check event performed by AP 300 of an AAA server along with existing DNS resolution of the AAA server to determine a current order or priority for the AAA server in the list of AAA servers configured for AP 300. Configuration/radio settings 350 may store a list of AAA servers configured for AP 300. The list of AAA servers of configuration/radio settings 350 may correspond to the list of AAA servers of the PACE application.

In one example, server manager 356 may perform a reachability check on the user configured primary AAA server only. Whenever the user changes the primary AAA server, the firmware may adapt for the reachability check. Firmware may emit events (e.g., PACE events, such as failover and fallback) to NMS 200.

In one example, when a user requests a refresh of a list of AAA servers, the entire list of AAA servers maintained by the PACE application may be updated based on the server checks of all AAA servers on the list of AAA servers. In one example, the user may change the primary AAA server via a user interface. Server manager 356 may detect the change in the primary AAA server and update the change for AP 300 such that the primary AAA server is changed without tear down of the WLAN.

In one example, the user may add or delete a secondary AAA server. This addition or deletion of the secondary AAA server may not modify/effect the primary AAA server. In response to the user adding or deleting an AAA server (e.g., secondary AAA server, tertiary AAA server, etc.) the server list maintained by PACE may be updated without tear down of the WLAN interface. Similarly, if the user adds or deletes a primary AAA server (e.g., a current AAA server configuration), the server list maintained by PACE may be updated and the new server information may be propagated. In this way, the user may add or delete an AAA server without WLAN bounce (e.g., causing the WLAN to go down and come back up, which may lead to client device de-authentication).

In some examples, irrespective of a randomize authentication and accounting server option, techniques of this disclosure may be beneficial because the randomize option permutes (e.g., re-arranges) the given AAA servers across the WLANs of an AP. For instance, there may be two APs, two WLANs, two AAA servers (x, y) and the randomize authentication and accounting server option may be enabled. In this instance, the order of AAA servers is the same for WLANs of same AP, but different on WLANs of other AP's. For example, AP1 may receive a set of AAA servers for its WLANs (primary AAA server x, secondary AAA server y) and AP2 may receive a set of AAA servers for its WLANs (primary AAA server y, secondary AAA server x). Irrespective of the random priority of the AAA servers of AP1 and AP2, each AP may still include a cache that enables propagation of the network server statuses across WLANs managed by AP1 and AP2, respectively.

In some examples, performing server checks for multiple BSSes configured with the same set of AAA servers may be redundant and result in inefficiencies and an increased network load. For example, a first and second BSS of AP 300 may be configured with the same set of primary and secondary AAA servers. Conventionally, the AP may perform a server check for the first BSS of the primary AAA server and also perform a server check for the second BSS of the same primary AAA server, which is redundant and unnecessary. In another example, when the AP device performs a failover or a fallback to another AAA server in the set of AAA servers configured for the first BSS, the AP must independently determine whether to failover or fallback for the second BSS and any other BSSes configured with the same set of AAA servers, which may again result in increased network workload and inefficiencies. For example, a primary AAA server associated with the first BSS may be unavailable resulting in a failover to a secondary AAA server and de-authentication of a client device connected to the BSS. If the failover is not propagated to the other BSSes associated with the primary AAA server, then client devices connected to each of those other BSSes may also be de-authenticated. For example, if AP 300 supports 45 BSSes each configured with the same set of AAA servers and AP 300 performs a failover to a secondary AAA server for the first BSS, if the failover is not propagated to the other 44 BSSes then there may be 44 times that a client device is de-authenticated.

The techniques of this disclosure provide one or more technical advantages and practical applications. For example, the techniques enable server manager 356 of AP 300 to maintain cache 353 that stores statuses of AAA servers and based on the statuses stored in cache 353, facilitate proactive failover and/or fallback across WLANs and/or BSSes supported by AP 300.

In one example, server manager 356 may perform a lookup in cache 353 for a primary AAA server configured for a BSS. Based on the lookup, server manager 356 may determine that a server check of the primary AAA server is required. Server manager 356 may perform the server check and determine that the primary AAA has a negative status (e.g., the primary AAA server is unreachable and/or unavailable). AP 300 may perform a failover to the secondary AAA server for that BSS and then server manager 356 may update cache 353 to mark the status of the primary AAA server as negative. Server manager 356, based on the updated status in cache 353, may proactively propagate the failover to the secondary AAA server for other BSSes configured with the same set of AAA servers.

AP 300 may function similarly for performing fallback to the primary AAA server once the primary AAA server is restored. For example, AP 300 may perform a fallback to the primary AAA server for the BSS once the primary AAA server is reachable and available and AP 300 may propagate the fallback to the BSSes configured to use the same primary AAA server.

In this way, techniques of this disclosure potentially avoid redundant server checks on AAA servers configured for multiple BSSes and facilitate propagation of AAA server failover and fallback across the BSSes. Thus, techniques of this disclosure may reduce network loads and increase network efficiency.

Although aspects of the disclosure are described with respect to AP 300, the disclosure is not so limited, aspects of the disclosure may be performed by any NAS device, such as one of NAS devices 108 from FIG. 1 (e.g., AP 142A-1, switch 146A, router 147A, etc.). AP 300 may be one example of an NAS device. In other examples, other types of NAS devices may perform the functionality of AP 300. Additionally, while aspects of the disclosure are described with respect to propagating failover and fallback across multiple sets of client devices organized by WLANs and/or BSSes of a NAS device, the disclosure is not so limited, and in some examples, failover and fallback of a NAS device may be propagated to sets of client devices organized by other NAS devices.

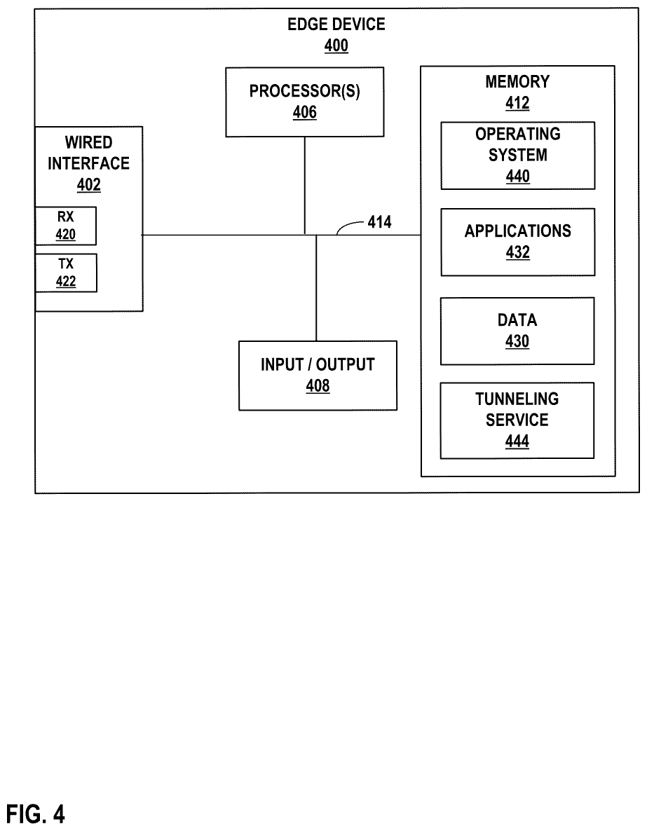

FIG. 4 is a block diagram illustrating an example edge device 400, in accordance with one or more techniques of this disclosure. Edge device 400 comprises a cloud-managed, wireless local area network (LAN) controller. Edge device 400 may be used to implement, for example, any of edge devices 150 in FIG. 1. In such examples, edge device 400 comprises an on-premises device at a site 102 that is in communication with NMS 130 and one or more on-premises NAS devices 108, e.g., one or more APs 142, switches 146, or routers 147, from FIG. 1. Edge device 400 with NMS 130 and may operate to extend certain microservices from NMS 130 to the on-premises NAS devices 108 while using NMS 130 and its distributed software architecture for scalable and resilient operations, management, troubleshooting, and analytics.

In this example, edge device 400 includes a wired interface 402, e.g., an Ethernet interface, a processor 406, input/output 408, e.g., display, buttons, keyboard, keypad, touch screen, mouse, etc., and a memory 412 coupled together via a bus 414 over which the various elements may interchange data and information. Wired interface 402 couples edge device 400 to a network, such as network 134 shown in FIG. 1 and/or any local area networks. Wired interface 402 includes a receiver 420 and a transmitter 422 by which edge device 400 receives/transmits data and information to/from any of NAS devices 108 and NMS 130. Though only one interface is shown by way of example, edge device 400 may have multiple communication interfaces and/or multiple communication interface ports.

Memory 412 stores executable software applications 432, operating system 440 and data/information 430. Data 430 may include a system log and/or an error log that stores event data, including behavior data, for edge device 400. Tunneling service 444 provides on-premises tunnel termination from APs and other NAS devices. Tunneling service 444 further provides a secure tunnel proxy to NMS 130. In one scenario, one or more of the NAS devices 108, e.g., switch 146A, may not support establishment of secure tunnels, e.g., WebSocket or RadSec tunnels, directly with NMS 130. In this scenario, tunneling service 444 of edge device 400 provides a tunnel proxy to, e.g., enable network data of switch 146A to be tunneled to NMS 130 using a WebSocket.

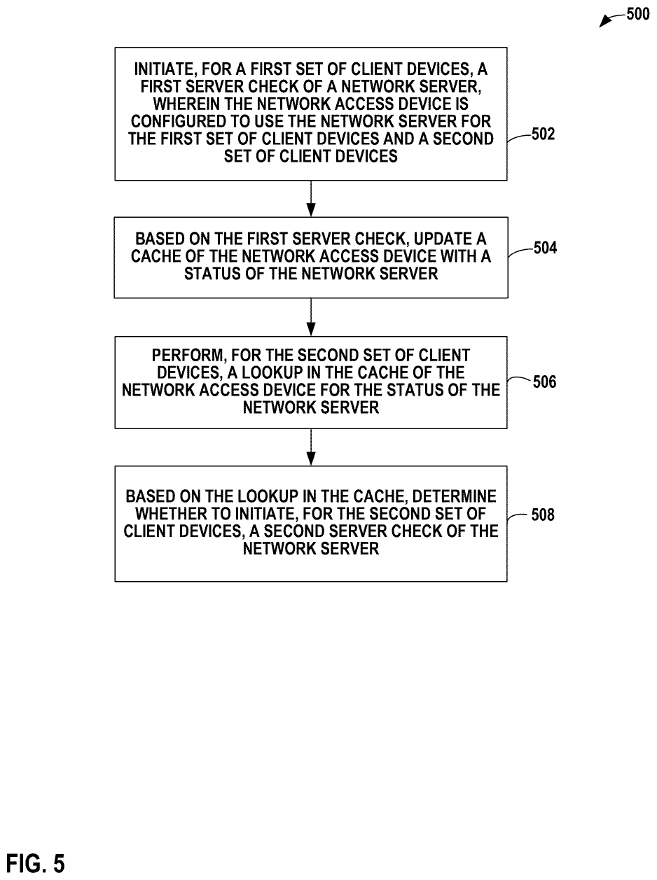

FIG. 5 is a flow chart illustrating an example operation of server management at a network access server device, in accordance with one or more techniques of this disclosure. The example operation of FIG. 5 is described with respect to AP 300 of FIG. 3. In one example, the operation of FIG. 5 may be performed by other NAS devices, such as NAS devices 108 from FIG. 1.

AP 300 initiates, for a first set of client devices, a first server check of a network server, where AP 300 is configured to use the network server for the first set of client devices and a second set of client devices associated with AP 300 (502). Based on the first server check, AP 300 updates cache 353 of AP 300 with a status of the network server (504). The status of the network server may be positive or negative. A positive status may indicate that the network server is reachable and available, while a negative status may indicate that the network server is at least one of not reachable or not available. The network server may be an Authentication, Authorization, and Accounting (AAA) server.

AP 300 may perform, for the second set of client devices, a lookup in cache 353 of AP 300 for the status of the network server (506). Based on the lookup in cache 353, AP 300 may determine whether to initiate, for the second set of client devices, a second server check of the network server (508). If the status of the network server in cache 353 is positive, AP 300 may determine not to initiate the second server check of the network server for the second set of client devices. If the status of the network server in cache 353 is negative, AP 300 may determine to initiate the second server check of the network server for the second set of client devices. In one example, based on a timestamp associated with the status of the network server in cache 353, AP 300 may determine whether to initiate the second server check of the network server for the second set of client devices. For instance, AP 300 may, based on the timestamp, determine that an amount of time that satisfies a threshold has passed such that AP 300 may initiate the second server check.

In some examples, AP 300 may, based on the status of the network server, perform one of a failover from the network server or a fallback to the network server for the first set of client devices and propagate one of the failover or the fallback of the network server to the second set of client devices. In one example, to propagate the one of the failover or the fallback of the network server to the second set of client devices, AP 300 is configured to update a mapping of the first set of client devices and the second set of client devices to an active network server. The active network server, based on the status of the network server, may be one of the network server or a secondary network server.

In one example, based on the status of the network server indicating that the network server is at least one of not reachable or not available, AP 300 may perform a failover from the network server to a secondary network server for the first set of client devices. AP 300 may propagate the failover from the network server to the secondary network server to the second set of client devices. In one example, based on the status of the network server indicating that the network server is reachable and available, AP 300 may perform a fallback from a secondary network server to the network server for the first set of client devices. AP 300 may propagate the fallback from the secondary network server to the network server to the second set of client devices associated with AP 300.

The first set of client devices may include a first BSS on a first frequency band supported by AP 300 and the second set of client devices may include a second BSS on one of the first frequency band or a second frequency band supported by AP 300. In some examples, the network server may provide at least one of an authentication service or an accounting service for the first set of client devices and the second set of client devices.

The techniques of this disclosure provide one or more technical advantages and practical applications. For example, the techniques enable a NAS device (e.g., AP 300) to maintain a cache that stores statuses of network servers and based on the statuses stored in the cache, proactively propagate failover and/or fallback across sets of client devices supported by the NAS device.

For ease of understanding techniques of the disclosure may be described with respect to AAA servers (e.g., AAA servers 110). However, the techniques of the disclosure are not limited to AAA servers. For example, techniques of the disclosure may be performed with respect to any network servers.

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such as a processor or an integrated circuit device, such as an integrated circuit chip or chipset. Alternatively, or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random-access memory (RAM), read-only memory (ROM), non-volatile random-access memory (NVRAM), electrically erasable programmable read-only memory (EEPROM), Flash memory, magnetic or optical data storage media, and the like. In some examples, an article of manufacture may comprise one or more computer-readable storage media.

In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

In some examples, a cache may be hardware and/or software configured memory structure for data storage. A cache may be any memory structure configured to store data. In some examples, a cache may include data that is a copy of data stored in a different memory structure. In some examples, a cache may include data that is a result of an earlier computation and/or determination performed by the component that includes the cache or a different component. In some examples, a cache may provide faster and more convenient data retrieval.

Where a phrase similar to “at least one of A, B, and C” is used in the claims, it is intended that the phrase be interpreted to mean that A alone may be present in an embodiment; B alone may be present in an embodiment; C alone may be present in an embodiment; or that any combination of the elements A, B, and C may be present in a single embodiment, for example, A and B, A and C, B and C, or A and B and C.

Where a phrase similar to “one or more processors configured to X, Y, and Z” is used in the claims, it is intended that the phrase be interpreted to mean at least: that a processor A alone may perform functions X, Y, and Z; that two or more processors (e.g., processors A and B) may collectively perform functions X, Y, and Z; that a first processor A may perform functions X and Y and a second processor may perform function Z; or that a first processor A may perform function X, a second processor may perform function Y, and a third processor may perform function Z.

What is claimed is:

1. A network access device comprising:
memory; and
processing circuitry in communication with the memory and configured to:
initiate, for a first set of client devices, a first server check of a network server, wherein the network access device is configured to use the network server for the first set of client devices and a second set of client devices;
based on the first server check, update a cache of the network access device with a status of the network server;
perform, for the second set of client devices, a lookup in the cache of the network access device for the status of the network server; and
based on the lookup in the cache, determine whether to initiate, for the second set of client devices, a second server check of the network server.

2. The network access device of claim 1, wherein the status of the network server comprises one of positive or negative, wherein the positive status indicates that the network server is reachable and available, and wherein the negative status indicates that the network server is at least one of not reachable or not available.

3. The network access device of claim 2, wherein to determine whether to initiate the second server check, the processing circuitry is configured to, based on the status of the network server in the cache being positive, determine to not initiate the second server check of the network server for the second set of client devices.

4. The network access device of claim 2, wherein to determine whether to initiate the second server check, the processing circuitry is configured to, based on the status of the network server in the cache being negative, determine to initiate the second server check of the network server for the second set of client devices.

5. The network access device of claim 1, wherein to determine whether to initiate the second server check, the processing circuitry is configured to, based on a timestamp of the status of the network server, determine whether to initiate the second server check of the network server for the second set of client devices.

6. The network access device of claim 1, wherein the processing circuitry is configured to:
based on the status of the network server, perform one of a failover from the network server or a fallback to the network server for the first set of client devices; and
propagate the one of the failover or the fallback of the network server to the second set of client devices.

7. The network access device of claim 6, wherein to propagate the one of the failover or the fallback of the network server to the second set of client devices, the processing circuitry is configured to update a mapping of the first set of client devices and the second set of client devices to an active network server, wherein the active network server, based on the status of the network server, is one of the network server or a secondary network server.

8. The network access device of claim 1, wherein the processing circuitry is configured to:
based on the status of the network server indicating that the network server is at least one of not reachable or not available, perform a failover from the network server to a secondary network server for the first set of client devices; and
propagate the failover from the network server to the secondary network server to the second set of client devices.

9. The network access device of claim 1, wherein the processing circuitry is configured to:
based on the status of the network server indicating that the network server is reachable and available, perform a fallback from a secondary network server to the network server for the first set of client devices; and
propagate the fallback from the secondary network server to the network server to the second set of client devices.

10. The network access device of claim 1, wherein the first set of client devices comprises a first basic service set (BSS) on a first frequency band supported by the network access device, and wherein the second set of client devices comprises a second BSS on one of the first frequency band or a second frequency band supported by the network access device.

11. The network access device of claim 1, wherein the network server provides at least one of an authentication service or an accounting service for the first set of client devices and the second set of client devices.

12. The network access device of claim 1, wherein the network server is an Authentication, Authorization, and Accounting (AAA) server.

13. A method comprising:
initiating, for a first set of client devices, a first server check of a network server, wherein a network access device is configured to use the network server for the first set of client devices and a second set of client devices;
based on the first server check, updating a cache of the network access device with a status of the network server;
performing, for the second set of client devices, a lookup in the cache of the network access device for the status of the network server; and
based on the lookup in the cache, determining whether to initiate, for the second set of client devices, a second server check of the network server.

14. The method of claim 13, wherein the status of the network server comprises one of positive or negative, wherein the positive status indicates that the network server is reachable and available, and wherein the negative status indicates that the network server is at least one of not reachable or not available.

15. The method of claim 14, wherein determining whether to initiate the second server check comprises, based on the status of the network server in the cache being positive, determining to not initiate the second server check of the network server for the second set of client devices.

16. The method of claim 14, wherein determining whether to initiate the second server check comprises, based on the status of the network server in the cache being negative, determining to initiate the second server check of the network server for the second set of client devices.

17. The method of claim 13, wherein determining whether to initiate the second server check comprises, based on a timestamp of the status of the network server, determining whether to initiate the second server check of the network server for the second set of client devices.

18. The method of claim 13, further comprising:
based on the status of the network server, performing one of a failover from the network server or a fallback to the network server for the first set of client devices; and
propagating the one of the failover or the fallback of the network server to the second set of client devices.

19. The method of claim 18, wherein propagating the one of the failover or the fallback of the network server to the second set of client devices comprises updating a mapping of the first set of client devices and the second set of client devices to an active network server, wherein the active network server, based on the status of the network server, is one of the network server or a secondary network server.

20. Non-transitory computer-readable storage media comprising instructions that, when executed by processing circuitry, cause the processing circuitry to:
initiate, for a first set of client devices, a first server check of a network server, wherein a network access device is configured to use the network server for the first set of client devices and a second set of client devices;
based on the first server check, update a cache of the network access device with a status of the network server;
perform, for the second set of client devices, a lookup in the cache of the network access device for the status of the network server; and
based on the lookup in the cache, determine whether to initiate, for the second set of client devices, a second server check of the network server.
